(19) United States
(12) Patent Application Publication
(10) Pub. No.: US 2026/0279709 A1
(43) Pub. Date: Sep. 17, 2026

(54) RELAY

(71) Applicant: Hitachi Energy Ltd, Zürich (CH)

(72) Inventors: Gurusiddaiah KOTRAIAH, Karnataka (IN); Sinny BALIYA, Karnataka (IN); Shyamala BASHETHALLI, Bengaluru (IN); Bharath JITHENDRA, Bengaluru (IN)

(21) Appl. No.: 19/471,471

(22) PCT Filed: Apr. 4, 2024
(86) PCT No.: PCT/EP2024/059188

§ 371 Date: Oct. 1, 2025

(30) Foreign Application Priority Data
Apr. 6, 2023 (IN) 202341025939
May 19, 2023 (EP) 23174237.0

(51) Int. Cl. H01H 50/04; H01H 50/06; H01H 50/08; H01H 50/14

(52) U.S. Cl. CPC H01H 50/048; H01H 50/06; H01H 50/08; H01H 50/14

(57) ABSTRACT

The invention relates to a relay that comprises a base assembly, a relay mechanics module supported by the base assembly, and a housing element that houses the relay mechanics module and that is connected to the base assembly. The housing element comprises a flange configured for attaching the relay to a support. The relay can be mounted via the housing element in a rack or another support. In this way, facilitated handling is enabled.

### BACKGROUND

The present disclosure relates to a relay, particularly to a stand-alone relay.

A relay is an electrically operated switch. It consists of a set of input terminals for a single or multiple control signals, and a set of operating contact terminals. The switch may have any number of contacts in multiple contact forms, such as make contacts, break contacts, or combinations thereof.

FIG. 9 illustrates a known relay 100. As shown in exploded view, a U-shaped metal bracket 110 and a cover 120 are used for mounting the relay 100 to a support such as a rack (not shown). Further, a relay base 130 is used for providing electrical accessibility to the relay 100. The relay base 130 comprises sockets 132 into which electrical contact pins 102 of the relay 100 are inserted for providing electrical contact between the relay 100 and the relay base 130. On a side of the relay base 130 opposite the sockets 132, the relay base 130 has relay terminals which are provided for contacting with external electrical conductors. The electrical connection to the relay terminals is done using sockets inside the relay base 130. These sockets are crimped to the conductors using a special crimping tool and pushed into the relay base 130 for connection. For disconnection, a further special tool is needed.

Accordingly, special termination contact pins, sockets, crimping tools, and relay bases, i.e., a number of different parts are needed to realize mounting and electrical connection of the relay 100.

There is a need for an improved relay. Particularly, there is a need for a relay providing facilitated handling, which is simple to mount and install, which is safe, reliable, cost efficient, compact and/or which allows improved usability at optimized size.

### SUMMARY

The present technology is defined by the claims and the aspects discussed herein. In particular, according to the present invention, a relay is provided that comprises a base assembly, a relay mechanics module supported by the base assembly, and a housing element that houses the relay mechanics module and that is connected to the base assembly. The housing element may comprise a flange configured for attaching the relay to a support.

Thus, the relay can be mounted or attached to a support such as for example a rack via the housing element in a particularly suitable way. In this way, facilitated handling is enabled. Particularly, the flange of the housing element may be configured to support the entire mass of the relay. In other words, if attached to the support, the housing element may carry the whole weight of the relay. In this way no additional bracket or other accessory is needed for mounting the relay to a support such as a rack.

Accordingly, the relay can be mounted without using any special accessory.

Further, the flange of the housing element allows for a flush mounting of the relay. This makes the relay particularly suitable as a stand-alone relay.

Various embodiments of the present technology may implement the following features:

The housing element may be formed in one piece. In other words, the housing element may be made in one integral piece. In this way, particularly improved protection of the relay mechanics can be achieved. This may improve the safety of the relay. This may also improve handling of the relay.

The flange may extend in a plane, here briefly also referred to as the “plane of the flange”. This allows a suitable installation possibility in an installation opening of a support lying in one plane. With respect to the plane of the flange, the footprint of the base assembly may be smaller than the footprint of the flange. In this way, the relay can simply be pushed into the installation opening of the support for mounting on the support. Particularly, the relay may be so shaped that the flange projects or extends beyond the base assembly on two or more, preferably all sides when viewed in a direction perpendicular to the plane of the flange. This improves handling and mounting and, in particular, the possibility of fixing the relay to the support as well as the protection of the relay when installed.

Preferably, the relay may be shaped such that the flange extends beyond the rest of the relay on two or more, preferably all sides when viewed in a direction perpendicular to the plane of the flange.

The relay may have a main axis which is oriented perpendicular to the plane of the flange. The relay may be configured to be inserted into an installation opening of the support along an insertion direction that is parallel to the main axis for installation.

The relay may have a front end and a rear end, wherein the flange is disposed at the front end. The front end of the relay may comprise a planar front end surface area. The planar front end surface area may be oriented parallel to or coincide with the plane of the flange.

The relay may further comprise at least one connector terminal element for providing electrical accessibility to the relay. Specifically, the connector terminal element may be a fixedly mounted part of the relay. Specifically, the relay may be configured such that the connector terminal element is not adapted to be disconnected from the base assembly by a user of the relay. In this way, no additional elements or parts are needed to mount and connect the relay, apart from a standard tool for the connection of external cables, such as generic wiring. In this way, the relay is particularly easy and practical to use.

The base assembly may have a first side and a second side opposite the first side, wherein the first side faces the housing element. The at least one connector terminal element may be fixed to the second side of the base assembly. This is particularly advantageous for flush mounting.

The at least one connector terminal element may comprise screw terminals. This allows a user of the relay to connect external electrical cables or conductors to the relay particularly conveniently. Particularly, no special tool is required for the electrical connection.

The relay may further comprise flexible electrical conductors connecting relay contacts of the relay mechanics module to connector pins of the at least one connector terminal element. The connector pins may each electrically connected to at least one of the screw terminals. In this way, the screw terminals, which have a certain minimum size for ease of operation, can be electrically connected in a particularly suitable manner to the contacts of the relay mechanics module and may be arranged closer to each other. In this way, a particularly space-saving design of the relay can be achieved.

The electrical and mechanical connections between the relay contacts and the flexible electrical conductors can be established, as an example, by soldering. Alternatively, other mechanical connections such as clips or crimps can be used, for example.

The housing element may comprise a first side having an opening for receiving the relay mechanics module and/or for connecting to the base assembly. This enables particularly suitable protection of the relay mechanics module.

The housing element may further comprise a second side, preferably opposite the first side, wherein the flange is located on the second side.

The flange may extend from two, three, or four sides of the housing element. The flange may circumferentially surround the housing element, particularly in a closed circumferential form. This may enable a particularly reliable and secure attachment of the relay to the support.

The flange may have at least one hole for receiving a screw for fastening the relay to the support. For example, the flange may have at least two holes or at least three holes or at least four holes each configured to receive a fixing screw for fastening the relay to the support.

The housing element may be made from a transparent plastic material. This makes it possible to see the relay mechanics from the outside. For example, certain relay states, such as switch positions or indicators, can be recognized from the outside in this way,

Alternatively, the housing element may be made or covered by a non-transparent or opaque material. This makes it possible that the interior of the relay is not visually recognizable from the outside. This may further allow to provide certain technical information on the relay housing.

The housing element may be configured to protect the relay mechanics module against water and dust, e. g., as defined by ingress protection class IP40 or better. This is particularly achievable by a one-piece or integral construction of the housing and/or by a respective connection to the relay base, closing the housing opening.

The screw terminals may be configured for being connected to standard round or fork type lugs. In this way, a particularly simple electrical connection of the relay is possible.

Screw terminals may require the connection of cable connectors from the side, i.e., about perpendicular to the screw axis, which may ease the connection. To further improve the connectivity, screw terminals be provided as a row of terminals, while two or more rows may be arranged in steps, i.e., at different positions along the main axis of the relay.

The at least one connector terminal element may comprise a shrouding member for shrouding at least one, preferably all of the screw terminals. This allows, i.a., for an improved protection of a user of the relay from an electric shock. The shrouding member may be shaped essentially plate-like.

The shrouding member may be mounted movable between a shrouding position and an open position. Preferably, the shrouding member is mounted movable, for example pivotably vis-à-vis the rest of the connector terminal element between the shrouding position and the open position. The shrouding member may be mounted pivotably around a rotation axis that is oriented perpendicular to the main axis of the relay.

The configuration may be such that the shrouding member, when in the shrouding position, shrouds or overlaps the at least one of the screw terminals when viewed from a first direction, preferably a direction along the main axis of the relay, and leaves it open when viewed from a second direction. Preferably, when in the open position, the shrouding member leaves the at least one of the screw terminals open when viewed from the first direction. In this way, external cables can be easily connected, e.g., with the help of a screwdriver, to the screw terminals when the shrouding member is in its open position.

Preferably, the first direction is oriented parallel to the main axis of the relay, i.e., perpendicular to the plane of the flange, and the second direction is oriented perpendicular to the first direction. This allows the external cables to be led out from the side of the screw terminals when the shrouding member is in its shrouding position.

The at least one connector terminal element may be shaped step-like, preferably when viewed in a cross-section perpendicular to the plane of the flange. In this way a suitable lateral connection of external cables to the connector terminal element can be achieved.

The shrouding member may be made from a transparent plastic material. This allows a visual inspection of the screw terminals even when the shrouding member overlaps the screw terminal when viewed in the first direction normal to the plane of the flange of the housing element.

The shrouding member may comprise markings for individually marking the screw terminals. This enables improved safety with regard to correct electrical connection of the relay.

The base assembly may comprise markings for individually marking the screw terminals. This makes it easy to distinguish the screw terminals even if the shrouding member is broken or lost.

The relay may comprise two connector terminal elements.

The base assembly may comprise a base assembly top element on a first side and a base assembly bottom element on a second side, wherein the at least one connector terminal element is fixed to the base assembly bottom element. The housing element may be connected to the base assembly top element. The relay mechanics module may be connected to the base assembly top element.

The base assembly may support the relay mechanics while the housing element does not (directly) support the relay mechanics. In particular, the relay mechanics may be connected to the relay base assembly, preferably the base assembly top element, while the also housing element is connected to the relay base assembly, preferably the base assembly top element.

The base assembly top element may comprise at least one opening with at least one of the flexible electrical conductors passing therethrough.

The base assembly top element may at least partially extend into the housing element. This enables a particularly suitable mechanical connection between the base assembly top element and the housing element. This connection may be particularly strong to allow the housing element to support the entire relay when mounted to a support, such as a rack. This connection may also be tight to seal the relay mechanics against ambient conditions. The housing element may be fixed to side surfaces of the base assembly top element, for example via screw connections.

The relay may be in form of a stand-alone relay.

According to an alternative or additional aspect of the present invention, a relay is provided that comprise a base assembly, a relay mechanics module supported by the base assembly, and a housing element that houses the relay mechanics module and that is connected to the base assembly. The relay further comprises at least one connector terminal element for providing electrical accessibility to the relay. The base assembly has a first side and a second side opposite the first side, wherein the first side faces the housing element. The at least one connector terminal element is fixed to the second side of the base assembly.

The relay may further comprise flexible electrical conductors connecting relay contacts of the relay mechanics module to connector pins of the at least one connector terminal element.

The at least one connector terminal element may comprise screw terminals. The connector pins may be each electrically connected to at least one of the screw terminals, preferably via the flexible electrical conductors.

In particular, the present disclosure comprises the following aspects:
1a. A relay, comprising
   a base assembly (2),
   a relay mechanics module (4) supported by the base assembly (2), and
   a housing element (6) that houses the relay mechanics module (4) and that is connected to the base assembly (2).
1b. The relay of aspect 1a, wherein the housing element (6) comprises a flange (62) configured for attaching the relay to a support.
2. The relay of aspect 1 (i.e. 1a and/or 1b), wherein the housing element (6) is formed in one piece.
3. The relay of aspect 1 or 2, wherein the flange (62) extends in a plane (E), wherein with respect to the plane, the footprint of the base assembly (2) is smaller than the footprint of the flange.
4. The relay of aspect 3, wherein the relay is so shaped that the flange (62) extends beyond the base assembly (2) on all sides when viewed in a direction perpendicular to the plane (E).
5. The relay of any of the preceding aspects, further comprising at least one connector terminal element (8) for providing electrical accessibility to the relay.
6. The relay of aspect 5, the base assembly (2) having a first side (22) and a second side (24) opposite the first side, the first side facing the housing element (6),
   wherein the at least one connector terminal element (8) is fixed to the second side (24) of the base assembly (2).
7. The relay of aspect 5 or 6, wherein the at least one connector terminal element (8) comprises screw terminals (82).
8. The relay of aspect 7, further comprising flexible electrical conductors (10) connecting relay contacts (42) of the relay mechanics module (4) to connector pins (88) of the at least one connector terminal element (8), wherein the connector pins (88) are each electrically connected to at least one of the screw terminals (82).
9. The relay of any of the preceding aspects, wherein the housing element (6) comprises a first side (64) having an opening for receiving the relay mechanics module (4) and/or for connecting to the base assembly (2).
10. The relay of aspect 9, wherein the housing element (6) further comprises a second side (66), preferably opposite the first side (64), wherein the flange (62) is located on the second side.
11. The relay of any of the preceding aspects, wherein the flange (62) extends from two, three, or four sides of the housing element (6), and preferably circumferentially surrounds the housing element.
12. The relay of any of the preceding aspects, wherein the flange (62) has at least one hole (622) for receiving a screw (7) for fastening the relay to the support.
13. The relay of any of the preceding aspects, wherein the housing element (6) is made from a transparent plastic material.
14. The relay of any of the preceding aspects, wherein the housing element (6) is configured to protect the relay mechanics module (4) against water and dust, e. g. as defined by IP40.
15. The relay of any of the preceding aspects, comprising the features of aspect 7, wherein the screw terminals (82) are configured for being connected to standard round or fork type lugs.
16. The relay of any of the preceding aspects, comprising the features of aspects 5 and 7, wherein the at least one connector terminal element (8) comprises a shrouding member (84) for shrouding at least one of the screw terminals (82).
17. The relay of aspect 16, wherein the shrouding member (84) is mounted movable, preferably pivotably between a shrouding position and an open position on the at least one connector terminal element (8).
18. The relay of aspect 17, comprising the features of aspect 3, wherein the shrouding member (84) when in the shrouding position overlaps the at least one of the screw terminals (82) when viewed from a first direction (d1) normal to the plane (E), and leaves the at least one of the screw terminals open when viewed from a second direction (d2) perpendicular to the first direction.
19. The relay of aspect 18, wherein the at least one connector terminal element (8) is shaped step-like, preferably when viewed in a cross-section perpendicular to the plane (E).
20. The relay of any of aspects 16 to 19, wherein the shrouding member (84) is made from a transparent plastic material.
21. The relay of any of aspects 16 to 20, wherein the shrouding member (84) comprises markings (86) for individually marking the screw terminals (82).
22. The relay of any of the preceding aspects, comprising the features of aspect 7, wherein the base assembly (2) comprises markings (282) for individually marking the screw terminals (82)
23. The relay of any of the preceding aspects, comprising the features of aspect 5, wherein the relay comprises two connector terminal elements (8).
24. The relay of any of the preceding aspects, comprising the features of aspect 5, wherein the base assembly (2) comprises a base assembly top element (26) on a first side (22) and a base assembly bottom element (28) on a second side (24), wherein the at least one connector terminal element (8) is fixed to the base assembly bottom element (28).
25. The relay of aspect 24, comprising the features of aspect 8, wherein the base assembly top element (26) comprises at least one opening (262) with at least one of the flexible electrical conductors (10) passing therethrough.
26. The relay of aspect 24 or 25, wherein the base assembly top element (26) at least partially extends into the housing element (6), and/or wherein the housing element (6) is fixed to side surfaces of the base assembly top element (26).
27. The relay of any of the preceding aspects in form of a stand-alone relay.
28. A relay, comprising
   a base assembly (2),
   a relay mechanics module (4) supported by the base assembly (2), and
   a housing element (6) that houses the relay mechanics module (4) and that is connected to the base assembly (2),
   at least one connector terminal element (8) for providing electrical accessibility to the relay,
   the base assembly having a first side (22) and a second side (24) opposite the first side, the first side facing the housing element (6),
   wherein the at least one connector terminal element is fixed to the second side of the base assembly.
29. The relay of aspect 28, further comprising
   flexible electrical conductors (10) connecting relay contacts (42) of the relay mechanics module (4) to connector pins (88) of the at least one connector terminal element (8).
30. The relay of aspect 29, wherein the at least one connector terminal element (8) comprises screw terminals (82), wherein the connector pins (88) are each electrically connected to at least one of the screw terminals.

### SHORT DESCRIPTION OF THE DRAWINGS

The subject-matter of the disclosure will be explained in more detail with reference to preferred exemplary embodiments which are illustrated in the attached drawings.

FIG. 1 is a schematic perspective view of a relay according to the present technology.

FIG. 2 is a further schematic perspective view of such relay.

FIG. 3 is a schematic exploded view of a relay according to the present technology.

FIG. 4 is a schematic perspective view of a further relay according to the present technology.

FIG. 5 is a schematic perspective partial cross-sectional view of a relay according to the present technology.

FIG. 6 is a partial cross-sectional view of a relay according to the present technology.

FIG. 7 is a rear view of a relay according to the present technology.

FIGS. 8a to 8c show three relays according to the present technology having different sizes.

FIG. 8d illustrates an example of a front view of a relay according to the present technology, and FIG. 8e a rear or terminal view.

FIG. 9 is an exploded view of a relay assembly according to prior art.

### DETAILED DESCRIPTION

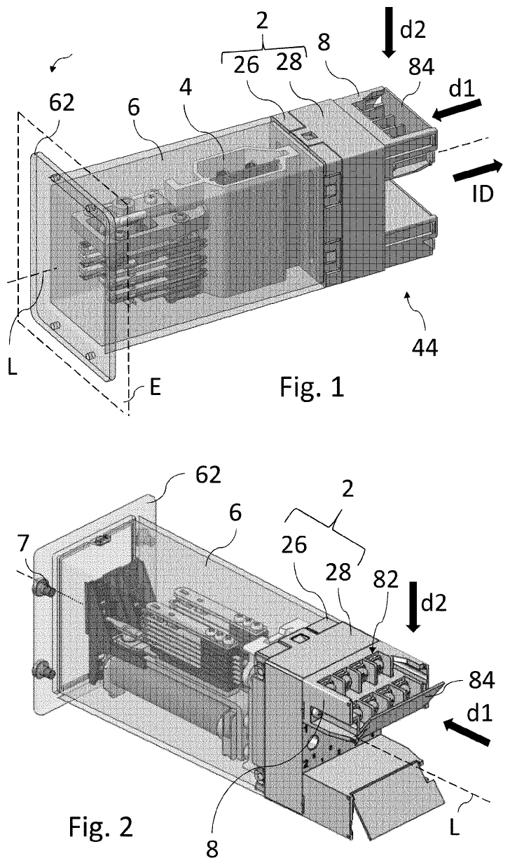

FIGS. 1 and 2 are schematic perspective views of a relay according to the present technology. The relay comprises a base assembly 2, a relay mechanics module 4, and a housing element 6. The relay mechanics module 4 may comprise contact-making and contact-breaking elements of the relay. The housing element 6 houses the relay mechanics module 4 and is mechanically connected to the base assembly 2.

The relay mechanics module 4 is supported by the base assembly 2. The housing element 6 may support the base assembly 2 and preferably the entire rest of the relay. The housing element 6 is a made in one piece from a plastic material.

The housing element 6 comprises a flange 62 that is configured for attaching the relay to a support (not shown) such as for example a rack or another support having an installation opening.

The flange 62 extends in a plane E as schematically indicated in FIG. 1. The footprint of the base assembly 2—with respect to the plane of the flange 62—is smaller than the footprint of the flange 62. Preferably, the footprint of the flange 62—with respect to the plane of the flange 62—is greater than the footprint of the rest of the relay. The relay can thus be suitably inserted into an installation opening of the support.

More specifically, the relay has a main axis L that is oriented normal or perpendicular to the plane E of the flange 62, wherein the relay is configured to be inserted for installation into the insertion opening of the support via an insertion movement along an insertion direction ID that is parallel to the main axis L.

The relay has a front end 42 and a rear end 44, wherein the flange 62 is at the front end 42 and the base assembly 2 is at the rear end 44.

Here, the flange 62 extends beyond the base assembly 2 on all sides when viewed in a direction perpendicular to the plane E, for example in a first direction d1 that is opposite to the insertion direction ID.

The cross-section normal to the main axis L (here briefly also referred to as the “normal cross-section”) of the housing element 6 except for the flange 62, equals at least substantially the corresponding cross-section of the base assembly 2. The base assembly 2 and the housing element 6 are arranged correspondingly with regard to their rotational positions in relation to the main axis L so that their cross-sections essentially coincide, i.e. align with each other.

The normal cross-section of the base assembly 2 and the normal cross-section of the housing element 2 except for the flange 62 may each be substantially rectangular as shown in FIGS. 1 and 2. Alternatively, these normal cross-sections may have another shape such as for example oval, circular, triangular, hexagonal etc.

In the illustrated example, the cross-section is substantially rectangular and the flange 62 extends from all four sides of the housing element 6 such that it circumferentially surrounds the rest of the housing element 6 in a closed circumferential form.

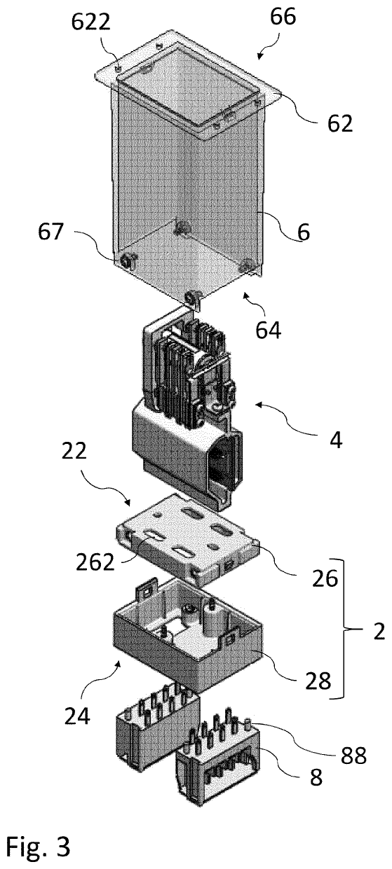

FIG. 3 shows a schematic exploded view of a relay. The housing element 6 comprises a first side or rear side 64 having an opening for receiving the relay mechanics module 4 and for connecting to the base assembly 2. The first side 64 is configured to support the base assembly 2. The configuration of the relay is such that the housing element 6 is not directly connected to the relay mechanics module 4. The housing element 6 is indirectly connected to the relay mechanics module 4 via the base assembly 2.

The housing element 6 further comprises a second end or front end 66 opposite the first end 64, wherein the flange 62 is located on the second side 66.

The flange 62 has at least one hole 622 for receiving a screw 7 for fastening the relay to the support. The flange 62 may have one hole, two holes, three holes, or any other number of holes, for example—as exemplarily illustrated in FIG. 3—four holes 622 each hole 622 for receiving one fastening screw 7 respectively.

The housing element 6 may be made from a transparent plastic material. In this way, it is possible to see inside the relay from the outside, for example, in order to detect an existing condition of the relay, e. g. via flag markings. Alternatively, the housing element 6 may be made from a non-transparent or opaque material or may be covered by an opaque cover. This prevents the inside of the relay from being seen from the outside. This may be desirable in the case of a PCB relay, for example.

As a further alternative, the front end of the housing element may be frosted. In this way, information about the relay such as relay type, connection information etc. that is easily recognizable from the outside can be suitably attached, while the inside of the relay is not or at best not clearly visible.

The housing element 6, particularly in connection with the base assembly 2, may be configured to protect the relay mechanics module 4 against water and dust, e. g. as defined by ingress protection class IP40.

The relay further comprises a connector terminal element 8 for providing electrical accessibility to the relay.

The base assembly 2 has a first side 22 and a second side 24 opposite the first side, wherein the first side 22 faces the housing element 6. The connector terminal element 8 is fixed to the second side 24 of the base assembly 2. In other words, the connector terminal element 8 is disposed opposite the housing element 6 with respect to the base assembly 2, particularly when seen along axis L.

The connector terminal element 8 comprises screw terminals 82 as exemplarily illustrated for example in FIG. 2. The screw terminals 82 preferably are configured for being connected to standard round or fork type lugs of generic wiring. For example, each of the screw terminals 82 may be configured to accommodate two conductors each of which may have a cross-section of for example 2.5 mm² crimped with standard round or fork type lugs.

Further, the connector terminal element 8 comprises a shrouding member 84 for shrouding at least one of the screw terminals 82, preferably for shrouding the screw terminals 82. The shrouding member 84 is configured to be movable, preferably pivotable vis-à-vis the rest of the connector terminal element 8 between a shrouding position as exemplarily sketched in FIG. 1 and an open position. For example, the shrouding member 84 can be mounted pivotably about a pivot axis that is oriented perpendicular to the main axis L of the relay. FIG. 3 shows an example of a half-open position by pivot movement.

When in the shrouding position, the shrouding member 84 covers or overlaps the screw terminals 82 as seen along the first direction d1 parallel to the main axis L of the relay and opposite the insertion direction ID. When in the open position, the shrouding member 84 leaves the screw terminals 82 uncovered as seen along the first direction d1 so that a user, e.g., standing behind the relay has free space to connect external cables for electrical connection to the relay with the screw terminals 82.

The connector terminal element 8 is shaped such that the shrouding member 84, when in the shrouding position, shrouds the screw terminals 82 from one side and leaves them open from another side. This allows protection of the screw terminals from direction d1 while allowing a wiring connection from the open side. More specifically, when viewed in a cross-section perpendicular to the plane E of the flange 62, the connector terminal element 8 is shaped such that the shrouding member 84 in the shrouding position shrouds the screw terminals 82 from the first direction d1 and leaves it open from a second direction d2 that is perpendicular to the first direction d1. In this way, a user standing behind the relay and looking at the connector terminal element 8 is protected by the shrouding member 82 when in the shrouding position, while external cables can be routed to the outside through a lateral gap between the shrouding member 84 and the screw terminals 82.

Preferably, the configuration is such that the shrouding member 84 is held in the shrouding position for example via a manually releasable latching connection.

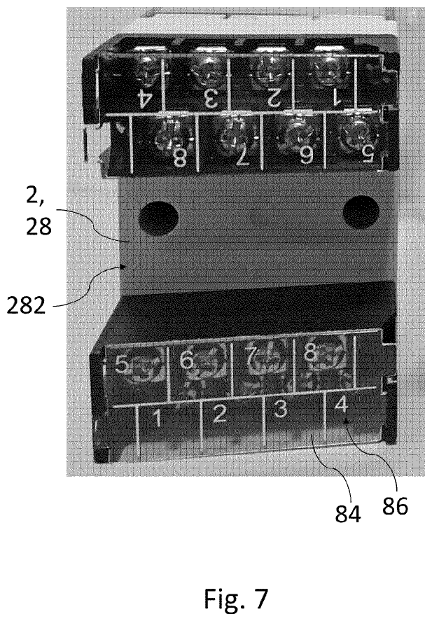

The shrouding member 84, as exemplarily sketched in FIG. 7, may be made from a transparent plastic material.

The shrouding member 84 may comprise markings 86 for individually marking the screw terminals 82. Additionally, the base assembly 2 may comprise markings 282 on a rear facing surface for individually marking the screw terminals 82. Corresponding double markings 84 and 282 increase safety when connecting external cables.

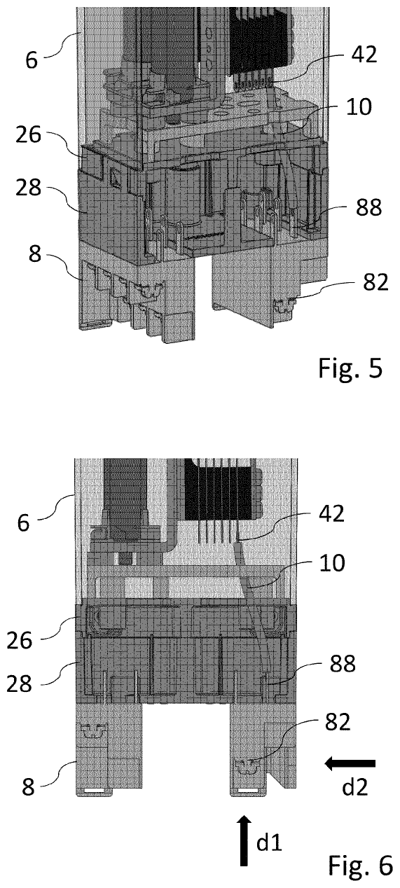

The connector terminal element 8 may have a step-like cross-section and comprise two rows of screw terminals 82 (compare, e.g., FIG. 2 or 5), which are positioned at different positions or heights, particularly with regard to axis L. This allows two rows of wiring to connect to the two rows of screw terminals easily. A particularly compact and effective design may be achieved thereby.

As sketched in FIGS. 1 to 3, the relay may comprise two connector terminal elements, particularly provided as opposite sides of the base assembly 2.

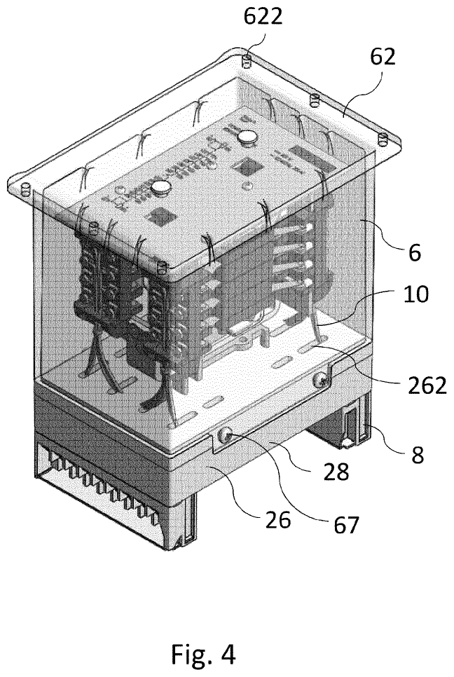

FIG. 4 illustrates a variation of the relay of FIG. 1 that differs for example in its dimensions and the way the housing 6 connects to the base assembly 2.

As illustrated in FIGS. 5 and 6, the relay further comprises flexible electrical conductors 10 connecting relay contacts 42 of the relay mechanics module 4 to connector pins 88 of the connector terminal element 8. Note that only one of the flexible conductors 10 is illustrated in FIGS. 5 and 6 for better identifiability. The connector pins 88 may each be electrically connected to at least one of the screw terminals 82.

The base assembly 2 comprises a base assembly top element 26 on a first side 22 and a base assembly bottom element 28 on a second side 24, wherein the connector terminal element 8 is fixed to the base assembly bottom element 28.

The base assembly top element 26 comprises openings 262 through which the flexible electrical conductors 10 may pass. The base assembly top element 26 and the base assembly bottom element 28 may be mechanically connected, e.g., by means of a snap-element. The two-part construction of the base assembly 2 particularly allows a compact design and allows for an easy connection of the connector pins 88 to the relay contacts 42 by means of flexible electrical conductors 10. Such connection may be achieved by means of a plug and socket connection, crimping and/or soldering.

The base assembly top element 26 at least partially extends into the housing element 6. This is advantageous in terms of a good connectivity between the housing element 6 and the base assembly top element 26. The housing element 6 may be fixed to side surfaces of the base assembly top element 26. For example, a screw connection 67 (compare FIG. 3 or 4) can be provided between the housing element 6 and the base assembly top element 26.

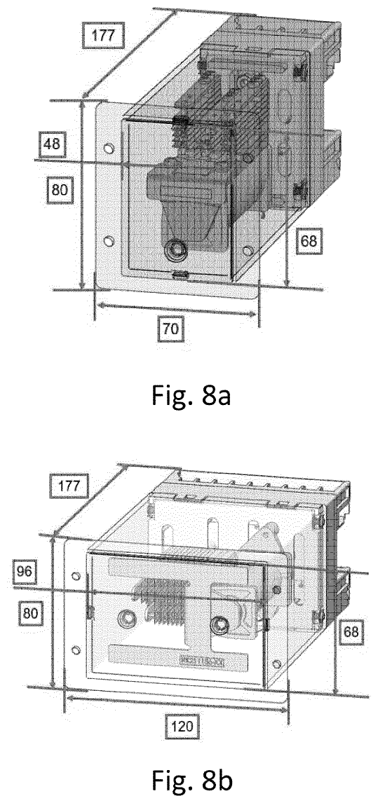

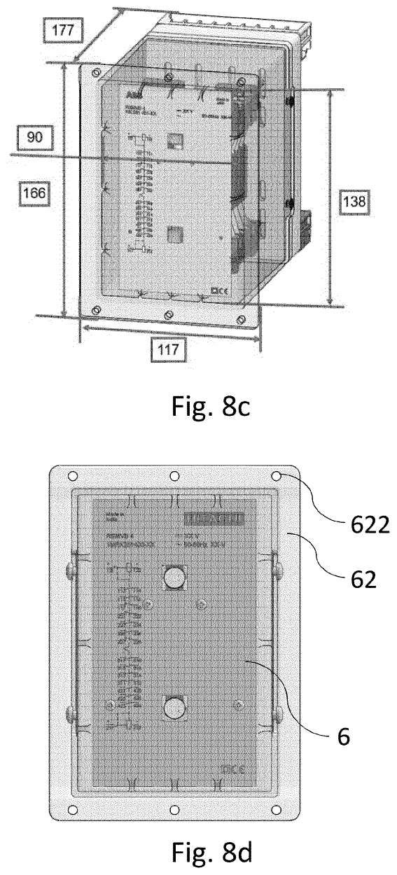

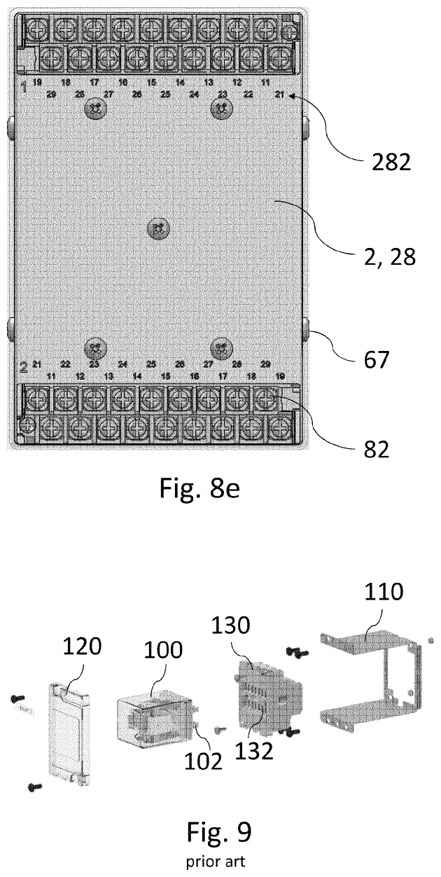

The relay may be a stand-alone relay. FIGS. 8a to 8c illustrate exemplarily relays having different sizes. The numerical values in rectangular boxes indicate preferred relevant dimensions of the respective relay in mm. FIG. 8a illustrates a 1-seat relay that offers eight terminal points per connector terminal element 8. FIG. 8b illustrates a 2-seat relay that offers for example eighteen terminal points per connector terminal element 8 and FIG. 8c illustrates a 4-seat relay that offers for example eighteen terminal points per connector terminal element 8. In any case, each terminal point may be designed to accommodate two connections.

The numerical values in the rectangular boxes shown in FIGS. 8a to 8c also show in each case exemplary sizes of the base assembly footprint and the flange footprint. For example, the footprint of the base assembly may be between 45% and 80%, preferably between 50% and 70% of the footprint of the flange. In case of a rectangular footprint, the aspect ratio of the base assembly footprint may be between 1.3 and 1.7, preferably between 1.4 and 1.6. The aspect ratio of the flange footprint may be between 1.0 and 1.7, preferably between 1.1 and 1.6. The flange may project beyond the footprint of the base assembly for example between 3 mm and 20 mm, preferably between 5 mm and 15 mm. FIG. 8d illustrates an example of a front view of a relay according to the present technology. In this example, the front side of the relay is opaque and includes indications regarding relay information.

FIG. 8e illustrates an example of a rear or terminal view of a relay according to the present technology (without shrouding members). Inter alia, the markings 282 for individually marking the screw terminals 82 are recognizable.

The following highlights some of the advantages a relay according to the present technology may achieve by means of the above discussed features:

The relay provides insulation shrouding on connector terminals as standard offering to protect user from electric shocks. This allows for improved user safety.

The relay can be mounted without use of any accessories such as racks or boxes or clamps and without use of a proprietary tool. This allows for facilitated handling.

Termination of each connection from a panel wiring can be achieved with use of generic market standard round or fork type cable lugs. This allows for facilitated handling.

Terminal numbers are marked on each connector shrouding against each terminal explicitly visible to the user. The same is also marked on the bottom side of the relay base assembly. In this way, the assignment of the terminal numbers can be easily recognized even if the shrouding member should not be present for any reason. This allows for mistake proof connections.

The relay can be provided for example as stand-alone relays in three sizes: 1-Seat, 2-Seat, and 4-Seat. This allows for a modular design on relay sizes.

The design of the relay allows for a particularly small construction size of the relay.

Compared to a Size-2 relay according to prior art approximately 50% less height with approximately 60% more terminations when stand-alone relay is offered.

While the present disclosure has been described in detail in the drawings and forgoing description, such description is to be considered illustrative or exemplary and not restrictive. Variations to the disclosed embodiments can be understood and effected by those skilled in the art and practicing the claimed subject-matter, from a study of the drawings, the disclosure, and the appended claims. In the claims, the word “comprising” does not exclude other elements, and the indefinite article “a” or “an” does not exclude a plurality. The mere fact that certain elements or steps are recited in distinct claims does not indicate that a combination of these elements or steps cannot be used to advantage, specifically, in addition to the actual claim dependency, any further meaningful claim combination shall be considered disclosed.

1. A relay, comprising
a base assembly,
a relay mechanics module supported by the base assembly, and
a housing element that houses the relay mechanics module and that is connected to the base assembly,
wherein the housing element comprises a flange configured for attaching the relay to a support.

2. The relay of claim 1, wherein the housing element is formed in one piece.

3. The relay of claim 1, wherein the flange extends in a plane, wherein with respect to the plane, a footprint of the base assembly is smaller than a footprint of the flange.

4. The relay of claim 3, wherein the flange extends beyond the base assembly on all sides when viewed in a direction perpendicular to the plane.

5. The relay of claim 1, further comprising at least one connector terminal element for providing electrical accessibility to the relay.

6. The relay of claim 5, the base assembly having a first side and a second side opposite the first side, the first side facing the housing element, wherein the at least one connector terminal element is fixed to the second side of the base assembly.

7. The relay of claim 5, wherein the at least one connector terminal element comprises screw terminals.

8. The relay of claim 7, further comprising flexible electrical conductors connecting relay contacts of the relay mechanics module to connector pins of the at least one connector terminal element, wherein the connector pins are each electrically connected to at least one of the screw terminals.

9. The relay of claim 1, wherein the housing element is configured to protect the relay mechanics module against water and dust,

10. The relay of claim 7, wherein the screw terminals are configured for being connected to standard round or fork type lugs.

11. The relay of claim 7, wherein the at least one connector terminal element comprises a shrouding member for shrouding at least one of the screw terminals.

12. The relay of claim 11, wherein the shrouding member is mounted movable, between a shrouding position and an open position on the at least one connector terminal element

13. The relay of claim 11, wherein the shrouding member comprises markings for individually marking the screw terminals.

14. The relay of claim 5, wherein the base assembly comprises a base assembly top element on a first side and a base assembly bottom element on a second side, wherein the at least one connector terminal element is fixed to the base assembly bottom element.

15. The relay of claim 14, further comprising:
at least one connector terminal element for providing electrical accessibility to the relay, wherein the at least one connector terminal element comprises screw terminals; and
flexible electrical conductors connecting relay contacts of the relay mechanics module to connector pins of the at least one connector terminal element, wherein the connector pins are each electrically connected to at least one of the screw terminals,
wherein the base assembly top element comprises at least one opening with at least one of the flexible electrical conductors passing therethrough.

16. The relay of claim 1, wherein the housing element comprises a first side having an opening for receiving the relay mechanics module and/or for connecting to the base assembly.

17. The relay of claim 16, wherein the housing element further comprises a second side, opposite the first side, and wherein the flange is located on the second side.

18. The relay of claim 1, wherein the housing element is configured to protect the relay mechanics module against water and dust, as defined by ingress protection class IP40.

19. The relay of claim 11, wherein the shrouding member is mounted pivotably between a shrouding position and an open position on the at least one connector terminal element.

20. The relay of claim 11, wherein the shrouding member is made from a transparent plastic material.
